(19) United States
(12) Patent Application Publication
(10) Pub. No.: US 2025/0063297 A1
(43) Pub. Date: Feb. 20, 2025

(54) ACOUSTIC LENS AND LOUDSPEAKER SYSTEM

(71) Applicant: Panasonic Intellectual Property Management Co., Ltd., Osaka (JP)

(72) Inventors: Kota NAKAHASHI, Osaka (JP); Shuji SAIKI, Nara (JP); Akihisa KAWAMURA, Osaka (JP); Satoshi TAKAYAMA, Mie (JP)

(21) Appl. No.: 18/934,815

(22) Filed: Nov. 1, 2024

Related U.S. Application Data
(63) Continuation of application No. PCT/JP2023/017253, filed on May 8, 2023.
(60) Provisional application No. 63/340,697, filed on May 11, 2022.

(30) Foreign Application Priority Data
Apr. 27, 2023 (JP) 2023-073204

(51) Int. Cl. H04R 1/34; G10K 11/30

(52) U.S. Cl. CPC H04R 1/345; G10K 11/30

(57) ABSTRACT

An acoustic lens includes an opening and a plurality of partition plates. A sound wave to be emitted from a loudspeaker is input to the opening. The plurality of partition plates form a plurality of sound paths through which the sound wave input to the opening passes. The plurality of partition plates include a first control mechanism and a second control mechanism. The first control mechanism controls directivity, in a first direction, of the sound wave that has passed through the plurality of sound paths and is output to outside. The second control mechanism controls directivity, in a second direction intersecting the first direction, of the sound wave that has passed through the plurality of sound paths and is output to outside.

### CROSS REFERENCE TO RELATED APPLICATIONS

This is a continuation application of PCT International Application No. PCT/JP2023/017253 filed on May 8, 2023, designating the United States of America, which is based on and claims priority of Japanese Patent Application No. 2023-073204 filed on Apr. 27, 2023 and U.S. Provisional Patent Application No. 63/340,697 filed on May 11, 2022. The entire disclosures of the above-identified applications, including the specifications, drawings and claims are incorporated herein by reference in their entirety.

### FIELD

The present invention relates to an acoustic lens that controls sound directivity, and a loudspeaker system.

### BACKGROUND

Patent Literature (PTL) 1 discloses an acoustic lens that improves the pointing direction of sound waves only in one direction that is predetermined.

### CITATION LIST

### Patent Literature

[PTL 1] Japanese Unexamined Patent Application Publication No. S63-73297

### SUMMARY

### Technical Problem

The present disclosure aims to provide an acoustic lens, etc., that can easily control the directivity of sound waves in each of two directions intersecting each other.

### Solution to Problem

An acoustic lens according to one aspect of the present disclosure includes an opening and a plurality of partition plates. A sound wave to be emitted from a loudspeaker is input to the opening. The plurality of partition plates form a plurality of sound paths through which the sound wave input to the opening passes. The plurality of partition plates include a first control mechanism and a second control mechanism. The first control mechanism controls directivity, in a first direction, of the sound wave that has passed through the plurality of sound paths and is output to outside. The second control mechanism controls directivity, in a second direction intersecting the first direction, of the sound wave that has passed through the plurality of sound paths and is output to outside.

A loudspeaker system according to one aspect of the present disclosure includes the acoustic lens and the loudspeaker that emits the sound wave to the opening of the acoustic lens.

### Advantageous Effects

The acoustic lens according to the present disclosure has an advantage that the directivity of sound waves in each of two directions intersecting each other is easily controlled.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an overview diagram illustrating a loudspeaker system according to a comparative example.

FIG. 2 is an overview diagram illustrating a usage example of a loudspeaker system including an acoustic lens according to Embodiment 1.

FIG. 3 is an overview diagram illustrating the configuration of the acoustic lens according to Embodiment 1.

FIG. 4 is an illustration of the first control mechanism of the acoustic lens according to Embodiment 1.

FIG. 5 is an illustration of the second control mechanism of the acoustic lens according to Embodiment 1.

FIG. 6 is an illustration of directivity in a first direction of the acoustic lens according to Embodiment 1.

FIG. 7 is an illustration of directivity in a second direction of the acoustic lens according to Embodiment 1.

FIG. 8 is an overview diagram illustrating the configuration of a loudspeaker system including an acoustic lens according to Embodiment 2.

FIG. 9 is a perspective view of a cross section of a loudspeaker system according to Embodiment 2.

FIG. 10 is a top view of the loudspeaker system according to Embodiment 2.

FIG. 11 is an overview diagram illustrating the configuration of an acoustic lens according to a variation of Embodiment 1.

### DESCRIPTION OF EMBODIMENTS

### Underlying Knowledge Forming Basis of the Present Disclosure

### Underlying Knowledge Forming Basis of the Present Disclosure

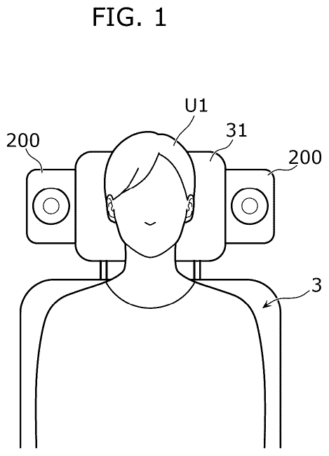

A conventional loudspeaker system that is provided in a seat in a moving body such as a vehicle, an aircraft, or a train, and reproduces, for instance, sounds or music for a user seated on the seat is known. FIG. 1 is an overview diagram illustrating loudspeaker system 200 according to a comparative example. Loudspeaker system 200 according to the comparative example is provided in headrest 31 of seat 3. In the example in FIG. 1, loudspeaker system 200 according to the comparative example is provided in the vicinity of the left ear and in the vicinity of the right ear of user U1 seated on seat 3.

With loudspeaker system 200 according to the comparative example, the directivity of sound waves emitted from a loudspeaker is uniform with respect to the front direction of the loudspeaker. Therefore, with loudspeaker system 200 according to the comparative example, sounds or music reproduced by the loudspeaker is likely to leak to a person seated on the seat next to seat 3 and a person seated on the seat behind seat 3. In other words, with loudspeaker system 200 according to the comparative example, there is a problem that sounds are likely to leak to a person other than target user U1.

In view of the above, the present disclosure aims to provide an acoustic lens that can easily control sounds that leak to a person other than target user U1, by devising the structure of an acoustic lens to easily control the directivity of sound waves in each of two directions intersecting each other.

More specifically, the acoustic lens according to a first aspect of the present disclosure includes an opening and a plurality of partition plates. A sound wave to be emitted from a loudspeaker is input to the opening. The plurality of partition plates form a plurality of sound paths through which the sound wave input to the opening passes. The plurality of partition plates include a first control mechanism and a second control mechanism. The first control mechanism controls directivity, in a first direction, of the sound wave that has passed through the plurality of sound paths and is output to outside. The second control mechanism controls directivity, in a second direction intersecting the first direction, of the sound wave that has passed through the plurality of sound paths and is output to outside.

This provides an advantage that the directivity of sound waves in each of two directions intersecting each other is easily controlled since the directivity of the sound waves in the first direction is controlled by the first control mechanism and the directivity of the sound waves in the second direction is controlled by the second control mechanism.

For example, in the acoustic lens according to a second aspect of the present disclosure, in the first aspect, the first control mechanism includes first partition plates which are aligned in the first direction and whose lengths in the traveling direction of the sound wave are mutually different, where the first partition plates are included in the plurality of partition plates. The second control mechanism includes second partition plates which are aligned in the second direction and whose lengths in the traveling direction of the sound wave are mutually different, where the second partition plates are included in the plurality of partition plates.

The above feature provides an advantage that the directivity of sound waves in the first direction is easily controlled by making the distances of the plurality of sound paths formed by the first partition plates mutually different. The above feature also provides an advantage that the directivity of the sound waves in the second direction is easily controlled by making the distances of the plurality of sound paths formed by the second partition plates mutually different.

For example, in the acoustic lens according to a third aspect of the present disclosure, in the second aspect, the lengths of the first partition plates in the traveling direction of the sound wave decrease in a direction parallel to the first direction.

This provides an advantage that it is easy to control on which side of the first direction the directivity of sound waves is to be set.

For example, in the acoustic lens according to a fourth aspect of the present disclosure, in the second or third aspect, the lengths of the second partition plates in the traveling direction of the sound wave decrease with increasing distance from the center of the opening along the second direction.

This provides an advantage that it is easy to set the directivity of sound waves closer to the center of the opening along the second direction.

For example, in the acoustic lens according to a fifth aspect of the present disclosure, in any one of the second to fourth aspects, at least one of the first partition plates or the second partition plates are each tilted at a predetermined angle relative to the traveling direction of the sound wave.

This provides an advantage that the directivity of sound waves is easily controlled by adjusting the predetermined angle.

For example, in the acoustic lens according to a sixth aspect of the present disclosure, in the fifth aspect, the predetermined angle is different from one partition plate to another partition plate.

This provides an advantage that directivity of sound waves is easily controlled without making the lengths of the plurality of partition plates mutually different.

For example, in the acoustic lens according to a seventh aspect of the present disclosure, in any one of the second to sixth aspects, the first direction and the second direction are orthogonal to each other.

This provides an advantage that with the first direction defined as a horizontal direction and the second direction defined as a vertical direction, the directivity of sound waves in each of the horizontal direction and the vertical direction is easily controlled.

For example, in the acoustic lens according to an eighth aspect of the present disclosure, in the first aspect, the plurality of partition plates are third partition plates aligned in the first direction. The first control mechanism includes the third partition plates whose lengths in the traveling direction of the sound wave are mutually different and which are each tilted at a first angle relative to the traveling direction of the sound wave. The second control mechanism includes the third partition plates that are tilted at second angles mutually different relative to the second direction and are line symmetric about the center of the third partition plates along the second direction when viewed along the traveling direction of the sound wave.

This provides an advantage that the directivity of sound waves in each of two directions intersecting each other is easily controlled since the directivity of the sound waves in the first direction is controlled by the first control mechanism and the directivity of the sound waves in the second direction is controlled by the second control mechanism.

For example, a loudspeaker system according to a ninth aspect of the present disclosure includes the acoustic lens according to any one of the first to eighth aspects, and the loudspeaker that emits the sound wave to the opening of the acoustic lens.

This provides an advantage that the same advantageous effects as produced by the aforementioned acoustic lens can be produced.

Hereinafter, embodiments of the present disclosure will be described with reference to the drawings. The embodiments described below each illustrate a general or specific example of the present disclosure. The numerical values, shapes, materials, elements, the arrangement positions and connections of the elements, steps, order of the steps, etc., shown in the following embodiments are mere examples, and therefore do not intend to limit the present disclosure. Geometric expressions such as “parallel” and “orthogonal” are used in some cases, but these expressions each do not present a mathematical strictness and include a difference or deviation that is substantially allowed. For example, in the following description, when an angle between two directions intersecting each other is 90 degrees plus or minus 1% to 5%, it can be said that these two directions are orthogonal. Moreover, an expression “at the same time” or “same” also includes a range that is substantially allowed.

Among elements in the following embodiments, elements not described in independent claims are illustrated as optional elements. The figures are schematic diagrams and are not necessarily precise illustrations. Elements that are essentially the same share like reference signs in the figures, and duplicate description may be omitted or simplified.

### Embodiment 1

### 1. Configuration

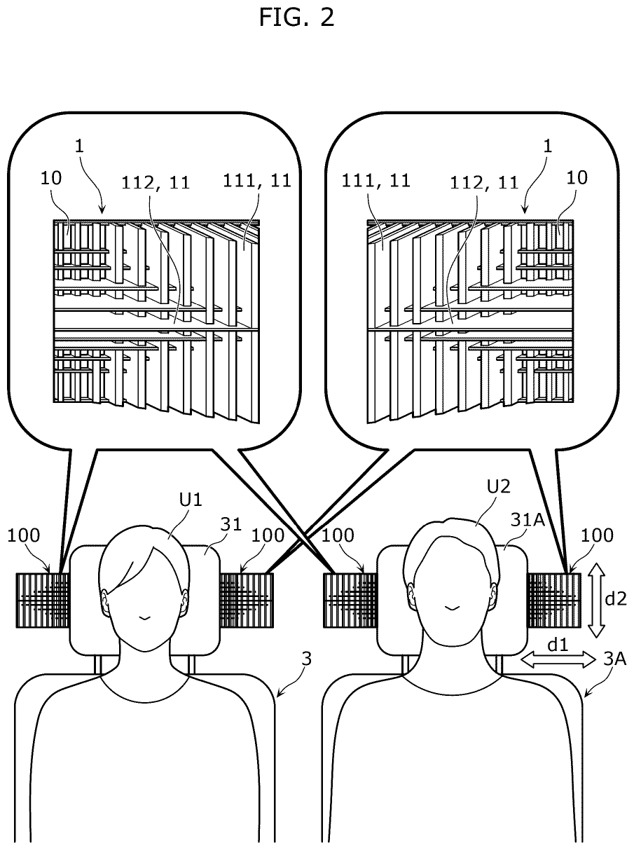

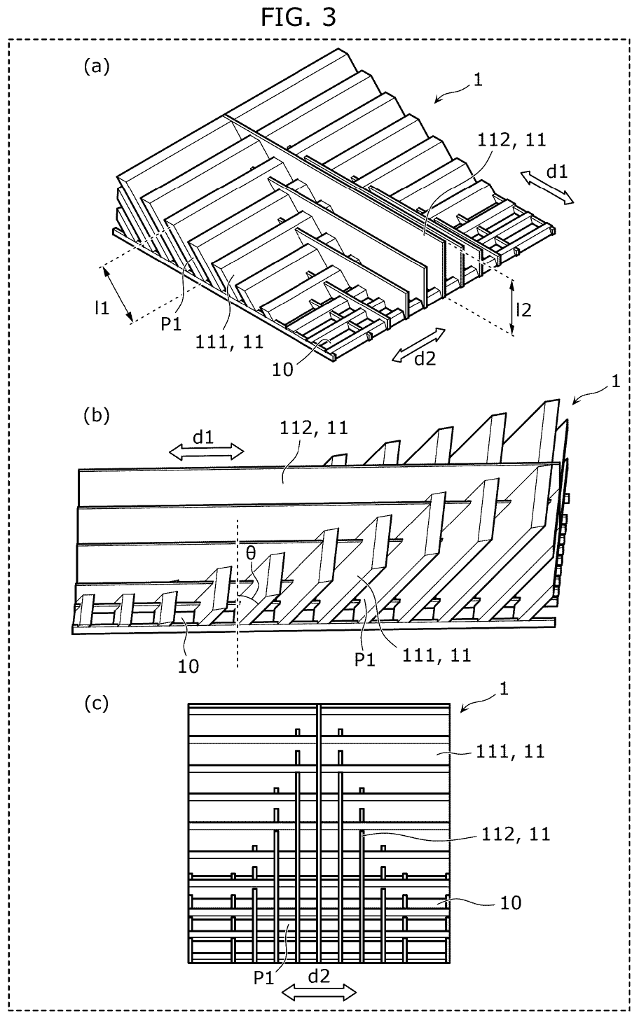

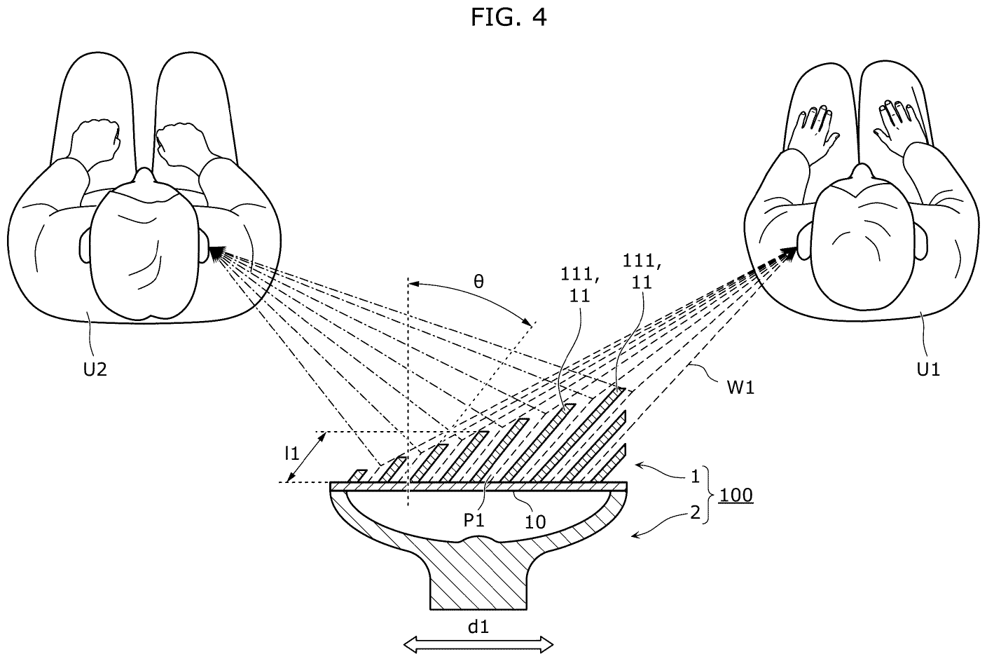

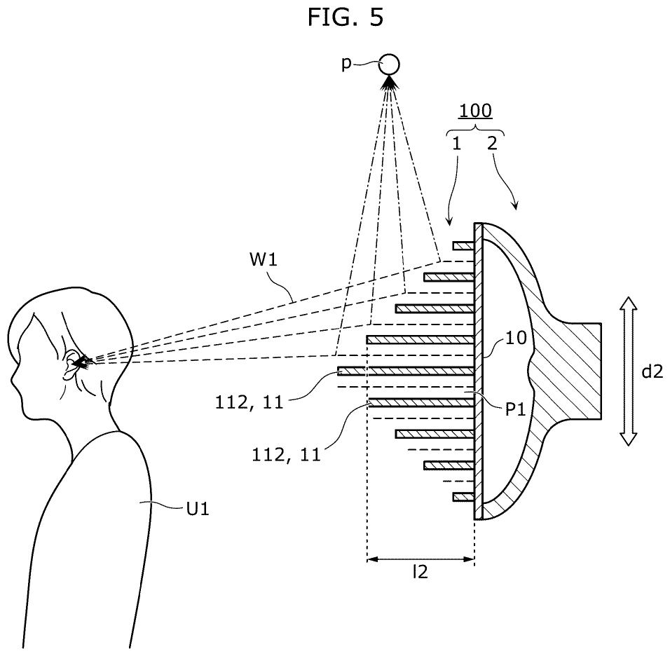

Hereinafter, acoustic lens 1 according to Embodiment 1 and loudspeaker system 100 including acoustic lens 1 will be described. FIG. 2 is an overview diagram illustrating a usage example of loudspeaker system 100 including acoustic lens 1 according to Embodiment 1. In FIG. 2, the indication of loudspeaker 2 is omitted. FIG. 3 is an overview diagram illustrating the configuration of acoustic lens 1 according to Embodiment 1. (a), (b), and (c) in FIG. 3 each show a perspective view of acoustic lens 1 viewed from a different angle. FIG. 4 is an illustration of a first control mechanism (to be described later) of acoustic lens 1 according to Embodiment 1. FIG. 5 is an illustration of a second control mechanism (to be described later) of acoustic lens 1 according to Embodiment 1.

As illustrated in FIG. 2, loudspeaker system 100 includes acoustic lens 1 and loudspeaker 2 (see FIG. 4 and FIG. 5). Loudspeaker system 100 is a system for allowing target user U1 to hear the sounds of sound waves W1 (see FIG. 4 and FIG. 5) emitted from loudspeaker 2 and emitted via acoustic lens 1.

In Embodiment 1, loudspeaker systems 100 are provided in each of seats 3 and 3A in a moving body such as a vehicle. Hereinafter, the following describes assuming that seat 3 is a driver's seat in a vehicle and seat 3A is a passenger's seat in the vehicle. Seats 3 and 3A are aligned in the right-left direction (horizontal direction) of the vehicle on the front side of the vehicle. The following describes assuming that the right-left direction (horizontal direction) of the vehicle is “first direction d1” and the height direction (vertical direction) of the vehicle is “second direction d2”.

Loudspeaker system 100 is provided at each of both ends of headrest 31 of seat 3 in first direction d1. In other words, loudspeaker system 100 is provided in the vicinity of the left ear and in the vicinity of the right ear of user U1 seated on seat 3. Loudspeaker system 100 is provided also at both ends of headrest 31A of seat 3A in first direction d1. In other words, loudspeaker system 100 is provided in the vicinity of the left ear and in the vicinity of the right ear of user U2 seated on seat 3A.

Loudspeaker 2 is a device that outputs sound waves W1 by converting the electric signals of, for instance, sound signals to vibrations of a vibration board. The size, shape, and structure of the vibration board, a magnetic circuit, a frame, or the like included in loudspeaker 2 are not specifically limited. In Embodiment 1, loudspeaker 2 is an electrodynamic loudspeaker including a cone diaphragm. Loudspeaker 2 emits sound waves W1 to opening 10 (to be described later) of acoustic lens 1. With this, sound waves W1 emitted from loudspeaker 2 pass through acoustic lens 1 and are emitted to outside (to the air).

As illustrated in FIG. 3, acoustic lens 1 includes opening 10 and a plurality of partition plates 11.

Opening 10 is a part to which sound waves W1 emitted from loudspeaker 2 are input. Specifically, opening 10 is a bottom part that faces loudspeaker 2 in acoustic lens 1 and is lattice-shaped formed by combining the plurality of partition plates 11. Sound waves W1 emitted from loudspeaker 2 pass through spaces provided between partition plates 11 in opening 10.

Each partition plate 11 is a member that is like a flat plate, and partition plate 11 itself does not vibrate easily. A material included in each partition plate 11 is, for example, wood, resin, metal, or ceramic, and is not specifically limited. As illustrated in FIG. 4 and FIG. 5, the plurality of partition plates 11 form a plurality of sound paths through which sound waves W1 input to opening 10 pass. In Embodiment 1, a space between neighboring partition plates 11 serves as sound path P1 through which sound waves W1 input to opening 10 pass. Sound waves W1 input to opening 10 then pass through sound paths P1 and are output to outside.

The plurality of partition plates 11 are included in a first control mechanism and a second control mechanism. The first control mechanism controls the directivity of sound waves W1 in first direction d1 that pass through the plurality of sound paths P1 and are output to outside. In Embodiment 1, the first control mechanism controls the directivity of sound waves W1, which pass through acoustic lens 1 and are output to outside, so that the sound pressure level of sound waves W1 is relatively higher on one side (user U1's side in FIG. 4) than the other side (user U2's side in FIG. 4) in first direction d1, i.e., the directivity is directed toward one side of first direction d1, as illustrated in FIG. 4. The second control mechanism controls the directivity of sound waves W1 in second direction d2 intersecting first direction d1 that pass through the plurality of sound paths P1 and are output to outside. In Embodiment 1, the second control mechanism controls the directivity of sound waves W1 so that the sound pressure level of sound waves W1 that pass through acoustic lens 1 and are output to outside is relatively higher near the center of opening 10 along second direction d2 than near an end portion of opening 10 along second direction d2 (the upper side or the lower side in FIG. 5), i.e., the directivity is directed toward the center of opening 10 along second direction d2.

As has already been described above, in Embodiment 1, first direction d1 is a horizontal direction and second direction d2 is a vertical direction. Accordingly, in Embodiment 1, first direction d1 and second direction d2 are orthogonal to each other. Note that first direction d1 and second direction d2 need to be or need not be orthogonal to each other.

In Embodiment 1, the first control mechanism includes first partition plates 111 among the plurality of partition plates 11. As illustrated in FIG. 3 and FIG. 4, first partition plates 111 are aligned in first direction d1 and lengths l1 of first partition plates 111 in the traveling direction of sound waves W1 are mutually different. The plurality of first partition plates 111 are arranged according to the condition that lengths l1 of first partition plates 111 in the traveling direction of sound waves W1 decrease from one end of first partition plates 111 (the right side in FIG. 4) to the other end (the left side in FIG. 4) in a direction parallel to first direction d1. Stated differently, first partition plates 111 are arranged so that lengths l1 of first partition plates 111 in the traveling direction of sound waves W1 increase as first partition plates 111 are located along first direction d1 closer to the directivity of sound waves W1 that is desired to be set.

The term “the traveling direction of sound waves W1” used herein is the traveling direction of sound waves W1 emitted from loudspeaker 2 and is not the traveling direction of sound waves W1 passing through acoustic lens 1. In Embodiment 1, the traveling direction of sound waves W1 corresponds to a direction orthogonal to both first direction d1 and second direction d2.

In Embodiment 1, two first partition plates 111, among first partition plates 111, that are located the closest and the second closest to one end (the right side in FIG. 4) of opening 10 in first direction d1 do not satisfy the above condition, but these first partition plates 111 may also be arranged according to the above condition.

In Embodiment 1, each of first partition plates 111 is tilted at predetermined angle θ relative to the traveling direction of sound waves W1, as illustrated in FIG. 3 and FIG. 4. Predetermined angle θ is an acute angle and is, for example, 45 degrees plus or minus 1 to 5 degrees. Predetermined angle θ needs to be an acute angle and may be, as one example, 30 degrees plus or minus 1 to 5 degrees, or 60 degrees plus or minus 1 to 5 degrees.

In Embodiment 1, the second control mechanism includes second partition plates 112 among the plurality of partition plates 11. As illustrated in FIG. 3 and FIG. 5, second partition plates 112 are aligned in second direction d2 and lengths l2 of second partition plates 112 in the traveling direction of sound waves W1 are mutually different. Second partition plates 112 are arranged according to the condition that lengths l2 of second partition plates 112 in the traveling direction of sound waves W1 decrease with increasing distance from the center of opening 10 along second direction d2. Stated differently, second partition plates 112 are arranged so that lengths l2 of second partition plates 112 in the traveling direction of sound waves W1 increase as second partition plates 112 are located along second direction d2 closer to the directivity of sound waves W1 that is desired to be set.

Directivity control of sound waves W1 in first direction d1 by the first control mechanism (first partition plates 111) will be described with reference to FIG. 4. In the first control mechanism, the lengths of sound paths P1, which are formed by the plurality of first partition plates 111, in the traveling direction of sound waves W1 decrease from one end of first partition plates 111 (the right side in FIG. 4) to the other end (the left side in FIG. 4) in a direction parallel to first direction d1, as illustrated in FIG. 4. Then, sound waves W1 pass through sound paths P1 and are emitted to outside (to the air).

As illustrated in FIG. 4, in the first control mechanism, the passing distance of sound wave W1 is changed according to the length of each first partition plate 111 for the location of an ear of user U1 seated on seat 3 and the location of an ear of user U2 seated on seat 3A, and directivity of sound waves W1 in first direction d1 is controlled by shifting the arrival time of sound wave W1.

Specifically, the passing of sound waves W1, which reach the ear of user U1 located on one side (the right side in FIG. 4) of first direction d1, toward one side of first direction d1 is hardly blocked by first partition plates 111, as indicated by broken lines. Thus, since there is no big difference between passing distances of sound waves W1 emitted from sound paths P1 partitioned by first partition plates 111 of acoustic lens 1 and a difference between arrival times of sound waves W1 from sound paths P1 is small, the negation of sound waves W1 due to the arrival time difference is less.

In contrast, the passing of sound waves W1, which reach the ear of user U2 located on the other side (the left side in FIG. 4) of first direction d1, toward the other side of first direction d1 is blocked by first partition plates 111, as indicated by dashed-dotted lines, and is blocked more noticeably and particularly toward one side of first direction d1.

Since this increases a difference between passing distances of sound waves W1 emitted from sound paths P1 partitioned by first partition plates 111 of acoustic lens 1, a difference between arrival times of sound waves W1 increases and an influence caused by the negation of sound waves W1 due to the arrival time difference is large.

Accordingly, since the sound pressure level of sound waves W1 that reach the ear of user U1 relatively increases than the sound pressure level of sound waves W1 that reach the ear of user U2, the directivity of sound waves W1 is directed toward one side of first direction d1.

As has already been described above, in Embodiment 1, each of first partition plates 111 is tilted at predetermined angle θ relative to the traveling direction of sound wave W1. Accordingly, in Embodiment 1, sound waves W1 are controlled so that the directivity of sound waves W1 is inclined more toward one side (the right side in FIG. 4) of first direction d1 compared with when first partition plates 111 are not tilted. The directivity of sound waves W1 in first direction d1 is adjustable by changing predetermined angle θ. For example, sound waves W1 are controlled so that the directivity of sound waves W1 is directed toward one side of first direction d1 as predetermined angle θ increases.

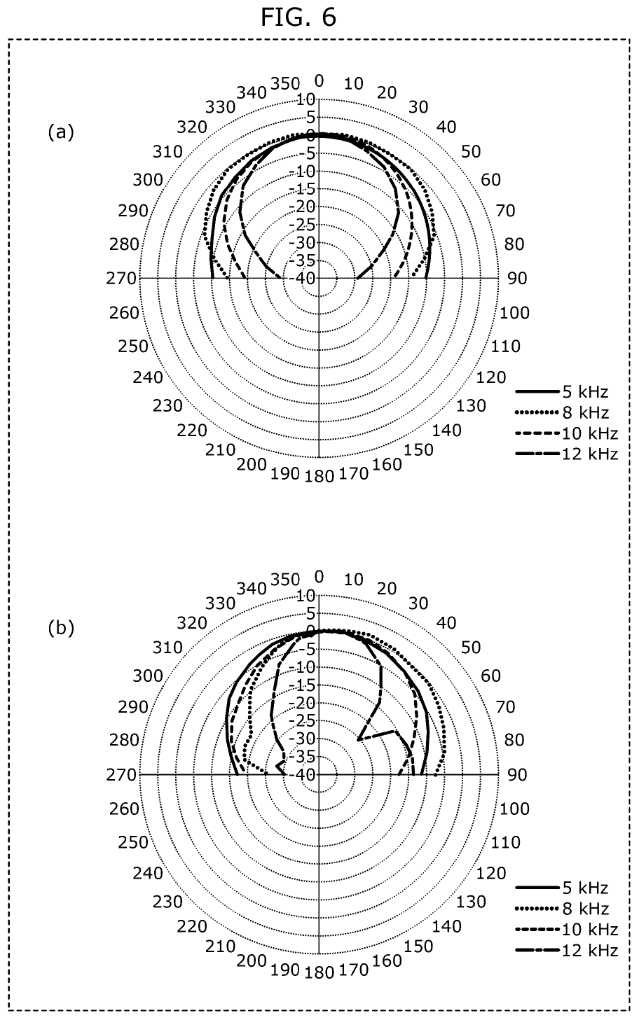

FIG. 6 is an illustration of directivity of acoustic lens 1 according to Embodiment 1 in first direction d1. FIG. 6 is a pointing characteristics diagram (polar patterns). (a) in FIG. 6 illustrates the directivity of sound waves W1 in first direction d1 when sound waves W1 are emitted from loudspeaker 2 without using acoustic lens 1. (b) in FIG. 6 illustrates the directivity of sound waves W1 in first direction d1 when sound waves W1 are emitted from loudspeaker 2 using acoustic lens 1. In FIG. 6, the solid line indicates the directivity of sound waves W1 whose frequency is 5 kHz, the dotted line indicates the directivity of sound waves W1 whose frequency is 8 kHz, the broken line indicates the directivity of sound waves W1 whose frequency is 10 kHz, and the dashed-dotted line indicates the directivity of sound waves W1 whose frequency is 12 kHz. The right side in FIG. 6 corresponds to one side of first direction d1 and the left side in FIG. 6 corresponds to the other side of first direction d1.

When sound waves W1 are emitted from loudspeaker 2 without using acoustic lens 1, as illustrated in (a) in FIG. 6, sound waves W1 are emitted substantially uniformly at the front of loudspeaker 2, and sound waves W1 hardly have directivity. In contrast, when sound waves 1 are emitted from loudspeaker 2 using acoustic lens 1, as illustrated in (b) in FIG. 6, the directivity of sound waves W1 gets wider on one side of first direction d1 and gets narrower on the other side of first direction d1. Thus, by using acoustic lens 1, it is possible to control the directivity of sound waves W1 in first direction d1.

Next, directivity control of sound waves W1 in second direction d2 by the second control mechanism (second partition plates 112) will be described with reference to FIG. 5. In the second control mechanism, the lengths of sound paths P1, which are formed by second partition plates 112, decrease with increasing distance from the center of opening 10 along second direction d2, as illustrated in FIG. 5. Sound waves W1 then pass through sound paths P1 and are emitted to outside (to the air).

As illustrated in FIG. 5, in the second control mechanism, the passing distance of sound wave W1 is changed according to the length of each second partition plate 112 for the location of the ear of user U1 seated on seat 3 and virtual point p located on one side (the upper side in FIG. 5) of second direction d2, and the directivity of sound waves W1 in second direction d2 is controlled by shifting the arrival time of sound wave W1.

Specifically, sound waves W1 that pass through sound paths P1 closer to the center of opening 10 along second direction d2 and reach the ear of user U1 located at a position corresponding to the center of opening 10 along second direction d2 is hardly blocked by second partition plates 112, as indicated by broken lines. In contrast, sound waves W1 that pass through one side of second direction d2 and reach virtual point p located on one side of second direction d2 is blocked by second partition plates 112, as indicated by dashed-dotted lines, and is blocked more noticeably and particularly toward the center of opening 10 along second direction d2.

Accordingly, since sound waves W1 toward virtual point p located on one side of second direction d2 have a large difference between passing distances of sound waves W1 emitted from sound paths P1 partitioned by second partition plates 112 of acoustic lens 1, a difference between arrival times of sound waves W1 after emission until reaching virtual point p increases and an influence caused by the negation of sound waves W1 due to the arrival time difference is large.

In contrast, sound waves W1 toward the ear of user U1 located at a position corresponding to the center of opening 10 along second direction d2 have a small difference between passing distances of sound waves W1 emitted from sound paths P1 partitioned by second partition plates 112 of acoustic lens 1, the negation of sound waves W1 due to the arrival time difference between sound waves W1 after emission until reaching the ear of user U1 is less.

Accordingly, since the sound pressure level of sound waves W1 that reach the ear of user U1 gets relatively higher than the sound pressure level of sound waves W1 that reach virtual point p, the directivity of sound waves W1 is directed toward the center of opening 10 along second direction d2.

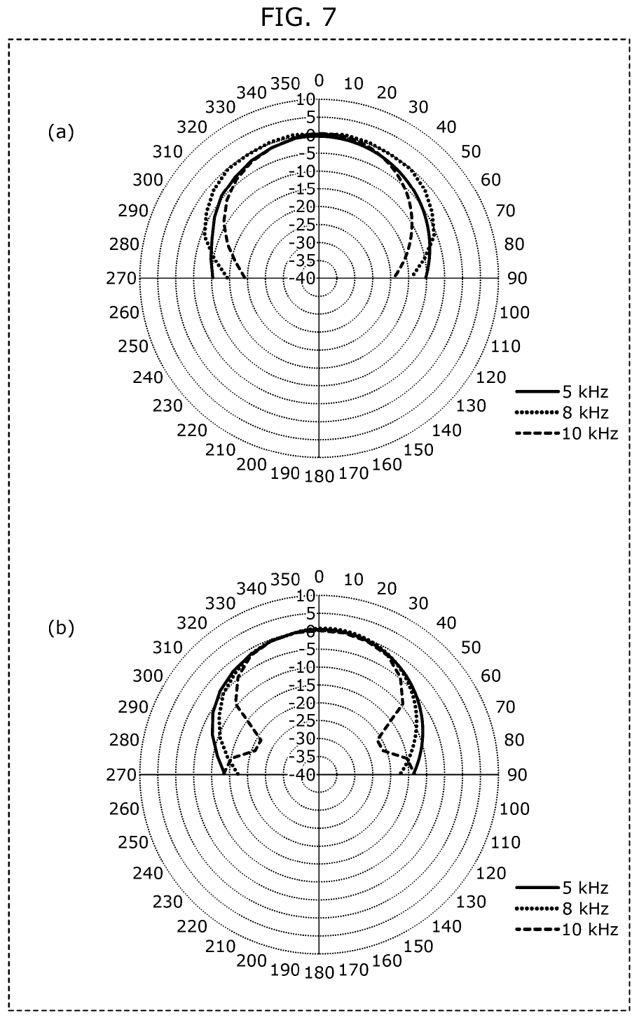

FIG. 7 is an illustration of directivity of acoustic lens 1 according to Embodiment 1 in second direction d2. FIG. 7 is a pointing characteristics diagram (polar patterns). (a) in FIG. 7 illustrates the directivity of sound waves W1 in second direction d2 when sound waves W1 are emitted from loudspeaker 2 without using acoustic lens 1. (b) in FIG. 7 illustrates the directivity of sound waves W1 in second direction d2 when sound waves W1 are emitted from loudspeaker 2 using acoustic lens 1. In FIG. 7, the solid line indicates the directivity of sound waves W1 whose frequency is 5 kHz, the dotted line indicates the directivity of sound waves W1 whose frequency is 8 kHz, and the broken line indicates the directivity of sound waves W1 whose frequency is 10 kHz. The right side in FIG. 7 corresponds to one side of second direction d2 and the left side in FIG. 7 corresponds to the other side of second direction d2.

When sound waves W1 are emitted from loudspeaker 2 without using acoustic lens 1, as illustrated in (a) in FIG. 7, sound waves W1 are emitted substantially uniformly at the front of loudspeaker 2, and sound waves W1 hardly have directivity. In contrast, when sound waves 1 are emitted from loudspeaker 2 using acoustic lens 1, as illustrated in (b) in FIG. 7, the directivity of sound waves W1 gets narrower at either of one side or the other side of second direction d2 at the front of loudspeaker 2. Thus, by using acoustic lens 1, it is possible to control the directivity of sound waves W1 in second direction d2.

### 2. Advantages

Hereinafter, advantages of acoustic lens 1 and loudspeaker system 100 according to Embodiment 1 will be described. As described above, with acoustic lens 1 according to Embodiment 1, it is possible to control the directivity of sound waves W1 in first direction d1 by the first control mechanism (first partition plates 111), and control the directivity of sound waves W1 in second direction d2 by the second control mechanism (second partition plates 112). Accordingly, acoustic lens 1 according to Embodiment 1 has an advantage that the directivity of sound waves W1 in each of two directions (first direction d1 and second direction d2) intersecting each other is easily controlled.

In Embodiment 1, with first direction d1 defined as a horizontal direction and second direction d2 defined as a vertical direction, acoustic lens 1 is capable of controlling the directivity of sound waves W1 in each of the horizontal direction and the vertical direction. Therefore, acoustic lens 1 according to Embodiment 1 and loudspeaker system 100 that uses acoustic lens 1 can overcome the problems that loudspeaker system 200 according to the comparative example has.

As illustrated in FIG. 2, loudspeaker system 100 is provided in the vicinity of the left ear and in the vicinity of the right ear of user U1 seated on seat 3, and acoustic lens 1 is placed so that the directivity of sound waves W1 is directed toward user U1 in the horizontal direction (first direction d1), for example. In this case, since sound waves W1 emitted from loudspeaker 2 are emitted via acoustic lens 1 so that the directivity of sound waves W1 is directed toward user U1 in the horizontal direction, sounds are unlikely to leak to user U2 seated on seat 3A next to seat 3. In this case, since sound waves W1 emitted from loudspeaker 2 are emitted via acoustic lens 1 so that the directivity of sound waves W1 is inclined also to the front of user U1 without being scattered in the vertical direction, sound waves W1 are unlikely to come behind seat 3 and sounds are unlikely to leak to a user seated on the seat behind seat 3.

Likewise, loudspeaker system 100 is provided in the vicinity of the left ear and in the vicinity of the right ear of user U2 seated on seat 3A next to seat 3, and acoustic lens 1 is placed so that the directivity of sound waves W1 is directed toward user U2 in the horizontal direction (first direction d1). In this case, since sound waves W1 emitted from loudspeaker 2 are emitted via acoustic lens 1 so that the directivity of sound waves W1 is directed toward user U2 in the horizontal direction, sounds are unlikely to leak to user U1 seated on seat 3. In this case, since sound waves W1 emitted from loudspeaker 2 are emitted via acoustic lens 1 so that the directivity of sound waves W1 is inclined also to the front of user U2 without being scattered in the vertical direction, sound waves W1 are unlikely to come behind seat 3A and sounds are unlikely to leak to a user seated on the seat behind seat 3A.

As described above, acoustic lens 1 according to Embodiment 1 and loudspeaker system 100 that uses acoustic lens 1 have an advantage that sounds that leak to a person other than target user U1 (or user U2) is easily suppressed.

### Embodiment 2

### 1. Configuration

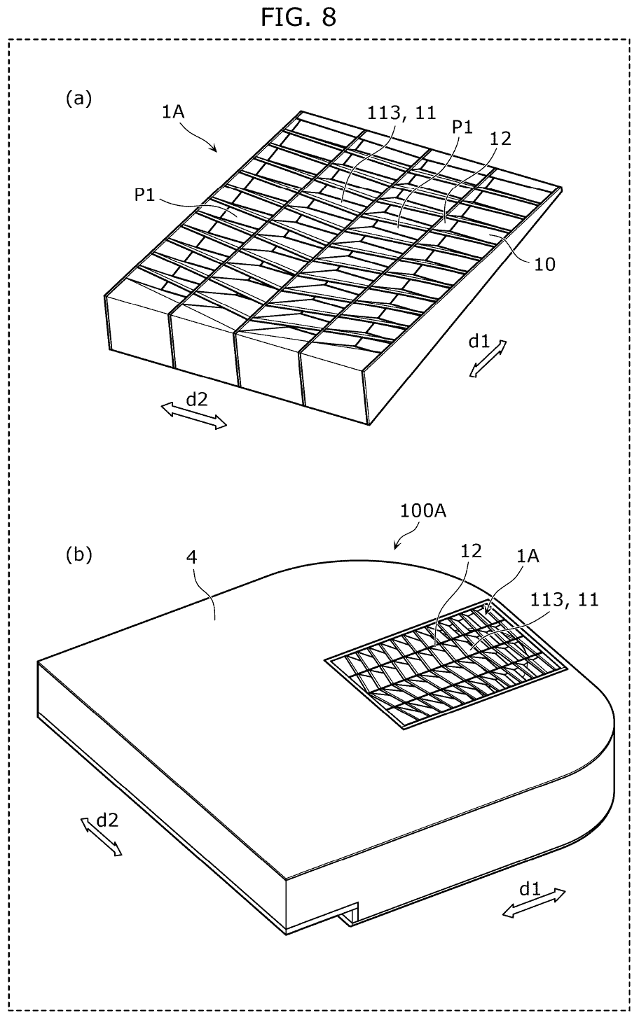

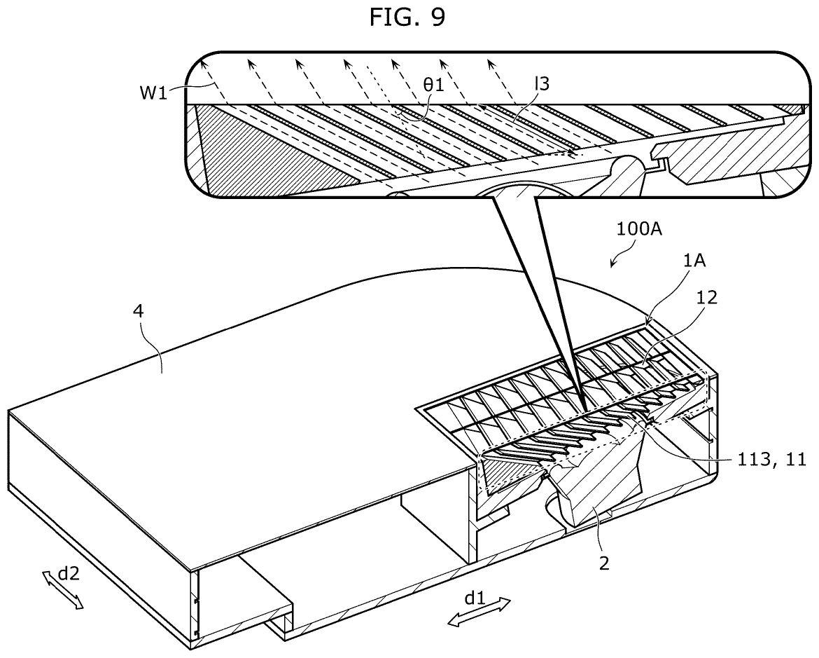

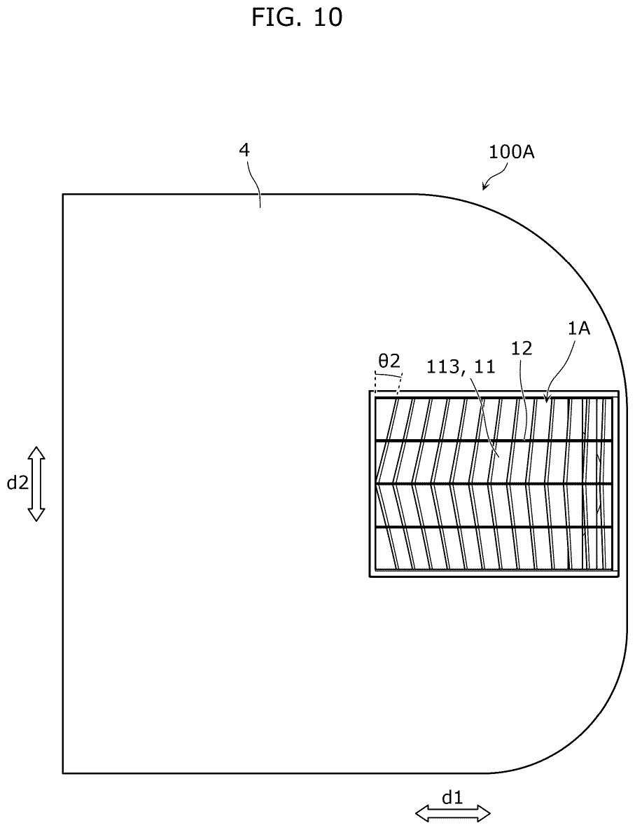

Hereinafter, acoustic lens 1A according to Embodiment 2 and loudspeaker system 100A including acoustic lens 1A will be described. FIG. 8 is an overview diagram illustrating the configuration of loudspeaker system 100A including acoustic lens 1A according to Embodiment 2. (a) in FIG. 8 illustrates a perspective view of acoustic lens 1A and (b) in FIG. 8 illustrates a perspective view of loudspeaker system 100A. FIG. 9 is a perspective view of a cross section of loudspeaker system 100A according to Embodiment 2. FIG. 10 is a top view of loudspeaker system 100A according to Embodiment 2. In the following description, description of the configuration common to the configuration of loudspeaker system 100 according to Embodiment 1 is omitted where necessary. In FIG. 8 and FIG. 10, the illustration of sound waves W1 is omitted.

As illustrated in (b) in FIG. 8, loudspeaker system 100A includes acoustic lens 1A, loudspeaker 2 (see FIG. 9), and case 4. Loudspeaker system 100A, like loudspeaker system 100 according to Embodiment 1, is a system for allowing target user U1 to hear the sounds of sound waves W1 emitted from loudspeaker 2 and emitted via acoustic lens 1A. Since the configuration of loudspeaker 2, the arrangement of loudspeaker system 100A, and the like are the same as those described in Embodiment 1, description is omitted.

Case 4 is a flat cuboid in shape, and holds acoustic lens 1A and loudspeaker 2. Specifically, loudspeaker 2 is accommodated in case 4. An opening is provided in case 4 and acoustic lens 1A is held by case 4 so that acoustic lens 1A is exposed to outside from the opening.

As illustrated in (a) in FIG. 8, acoustic lens 1A includes opening 10, a plurality of partition plates 11, and a plurality of division plates 12. In Embodiment 2, the plurality of partition plates 11 are third partition plates 113 aligned in first direction d1. The plurality of division plates 12 are made of the same material as each partition plate 11 and are aligned in second direction d2. Since each division plate 12 hardly contributes to the directivity control of sound waves W1, description is omitted.

In Embodiment 2, a first control mechanism includes third partition plates 113 whose lengths l3 in the traveling direction of sound waves W1 are mutually different and whose angles are each tilted at first angle θ1 relative to the traveling direction of sound waves W1. First angle θ1 is an acute angle and is, for example, 45 degrees plus or minus 1 to 5 degrees. First angle θ1 needs to be an acute angle and may be, as one example, 30 degrees plus or minus 1 to 5 degrees, or 60 degrees plus or minus 1 to 5 degrees.

Third partition plates 113 are arranged according to the condition that lengths l3 of third partition plates 113 in the traveling direction of sound waves W1 decrease from one end of third partition plates 113 (the left side in FIG. 9) to the other end (the right side in FIG. 9) in a direction parallel to first direction d1. Stated differently, third partition plates 113 are arranged so that lengths l3 of third partition plates 113 in the traveling direction of sound waves W1 increase as third partition plates 113 are located along first direction d1 closer to the directivity of sound waves W1 that is desired to be set.

In Embodiment 2, a second control mechanism includes third partition plates 113 that are arranged so that third partition plates 113 are tilted at second angles θ2 that are mutually different with respect to second direction d2 and are line symmetric about the center of opening 10 along second direction d2 when viewed along the traveling direction of sound waves W1 (the direction orthogonal to the paper plane in FIG. 10), as illustrated in FIG. 10. Third partition plates 113 are arranged according to the condition that second angles θ2 decrease from one end of third partition plates 113 (the left side in FIG. 10) to the other end (the right side in FIG. 10) in a direction parallel to first direction d1.

Second angle θ2 is in the range of, for example, from 0 degrees plus or minus 1 to 5 degrees to 20 degrees plus or minus 1 to 5 degrees, both inclusive. Second angle θ2 needs to be an acute angle (including 0 degrees) and may be, as one example, in the range of 30 degrees plus or minus 1 to 5 degrees, or less, or in the range of 60 degrees plus or minus 1 to 5 degrees, or less.

### 2. Advantages

Hereinafter, advantages of acoustic lens 1A and loudspeaker system 100A according to Embodiment 2 will be described. As described above, with acoustic lens 1A according to Embodiment 2, it is possible to control the directivity of sound waves W1 in first direction d1 by the first control mechanism (third partition plates 113) and the directivity of sound waves W1 in second direction d2 by the second control mechanism (third partition plates 113). Therefore, acoustic lens 1A according to Embodiment 2, like acoustic lens 1 according to Embodiment 1, has an advantage that the directivity of sound waves W1 in each of two directions (first direction d1 and second direction d2) intersecting each other is easily controlled.

Even in Embodiment 2, like in Embodiment 1, with first direction d1 defined as a horizontal direction and second direction d2 defined as a vertical direction, acoustic lens 1A is capable of controlling the directivity of sound waves W1 in each of the horizontal direction and the vertical direction. Accordingly, acoustic lens 1A according to Embodiment 2 and loudspeaker system 100A that uses acoustic lens 1A can overcome, as is the case of Embodiment 1, the problems that loudspeaker system 200 according to the comparative example has.

### OTHER EMBODIMENTS

Although Embodiments 1 and 2 have been described above, the present disclosure is not limited to Embodiments 1 and 2.

In Embodiment 1, first partition plates 111 are each tilted relative to the traveling direction of sound waves W1, but the present disclosure is not limited to this example. For example, only one or more of first partition plates 111 among first partition plates 111 may be tilted.

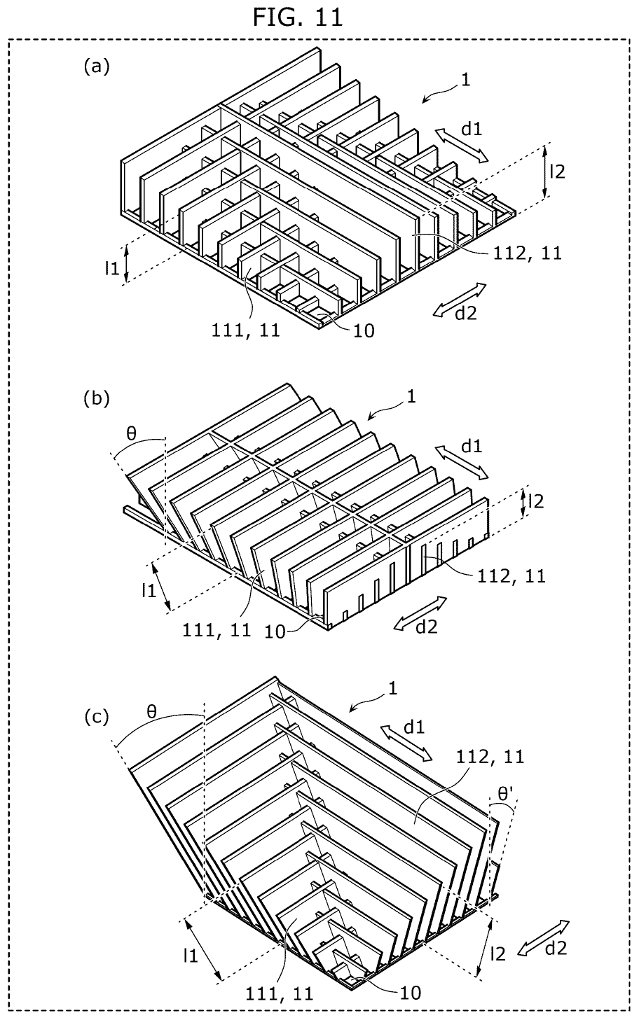

Acoustic lens 1A according to Embodiment 1 may have the configuration as illustrated in FIG. 11. FIG. 11 is an overview diagram illustrating the configuration of acoustic lens 1 according to a variation of Embodiment 1. For example, first partition plates 111 and second partition plates 112 may be each configured to be not tilted relative to the traveling direction of sound waves W1, as illustrated in (a) in FIG. 11. For example, first partition plates 111 may be arranged according to the conditions that lengths l1 of first partition plates 111 in the traveling direction of sound waves W1 are same and predetermined angle θ decreases from one end of first partition plates 111 (the deeper side in (b) in FIG. 11) to the other end (the front side in (b) in FIG. 11) in a direction parallel to first direction d1, as illustrated in (b) in FIG. 11.

As illustrated in (c) in FIG. 11, second partition plates 112 may be arranged so that lengths l2 of second partition plates 112 increase from one end of second partition plates 112 (the left side in (c) in FIG. 11) to the other end (the right side in (c) in FIG. 11) in a direction parallel to second direction d2. Second partition plates 112 may be each tilted at predetermined angle θ′ relative to the traveling direction of sound waves W1. Predetermined angle θ′ is an acute angle and is, for example, 45 degrees plus or minus 1 to 5 degrees. Predetermined angle θ′ needs to be an acute angle and may be, as one example, 30 degrees plus or minus 1 to 5 degrees, or 60 degrees plus or minus 1 to 5 degrees.

Other embodiments obtained by various modifications to the embodiments which may be conceived by those skilled in the art, and embodiments achieved by combining elements and functions described in each of the embodiments are also included in the scope of the present disclosure so long as they do not depart from the essence of the present disclosure.

### INDUSTRIAL APPLICABILITY

The present disclosure is useful as a member that controls the directivity of sound waves emitted from a loudspeaker.

1. An acoustic lens comprising:
an opening to which a sound wave to be emitted from a loudspeaker is input; and
a plurality of partition plates that form a plurality of sound paths through which the sound wave input to the opening passes, wherein
the plurality of partition plates include:
a first control mechanism that controls directivity of the sound wave in a first direction, the sound wave having passed through the plurality of sound paths and being output to an outside of the acoustic lens; and
a second control mechanism that controls directivity of the sound wave in a second direction, the sound wave having passed through the plurality of sound paths and being output to the outside, the second direction intersecting the first direction.

2. The acoustic lens according to claim 1, wherein
the first control mechanism includes first partition plates which are aligned in the first direction and whose lengths in a traveling direction of the sound wave are mutually different, the first partition plates being included in the plurality of partition plates, and
the second control mechanism includes second partition plates which are aligned in the second direction and whose lengths in the traveling direction of the sound wave are mutually different, the second partition plates being included in the plurality of partition plates.

3. The acoustic lens according to claim 2, wherein
the lengths of the first partition plates in the traveling direction of the sound wave decrease in a direction parallel to the first direction.

4. The acoustic lens according to claim 2, wherein
the lengths of the second partition plates in the traveling direction of the sound wave decrease with increasing distance from a center of the opening along the second direction.

5. The acoustic lens according to claim 2, wherein
at least one of the first partition plates or the second partition plates are each tilted at a predetermined angle relative to the traveling direction of the sound wave.

6. The acoustic lens according to claim 5, wherein
the predetermined angle is different from one partition plate to another partition plate.

7. The acoustic lens according to claim 2, wherein
the first direction and the second direction are orthogonal to each other.

8. The acoustic lens according to claim 1, wherein
the plurality of partition plates are third partition plates aligned in the first direction,
the first control mechanism includes the third partition plates whose lengths in the traveling direction of the sound wave are mutually different and which are each tilted at a first angle relative to the traveling direction of the sound wave, and
the second control mechanism includes the third partition plates that are tilted at second angles mutually different relative to the second direction and are line symmetric about a center of the third partition plates along the second direction when viewed along the traveling direction of the sound wave.

9. A loudspeaker system comprising:
the acoustic lens according to claim 1; and
the loudspeaker that emits the sound wave to the opening of the acoustic lens.
